(19) United States
(12) Patent Application Publication
(10) Pub. No.: US 2020/0357060 A1
(43) Pub. Date: Nov. 12, 2020

(54) RULES/MODEL-BASED DATA PROCESSING SYSTEM FOR INTELLIGENT DEFAULT RISK PREDICTION

(71) Applicant: Fair IP, LLC, Santa Monica, CA (US)

(72) Inventors: Ruslana Dalinina, West Hills, CA (US); David Scott Boren, Woodland Hills, CA (US); David Luan Nguyen, Playa Vista, CA (US); Gilad Meron Ashpis, Playa del Rey, CA (US)

(21) Appl. No.: 16/871,830

(22) Filed: May 11, 2020

Related U.S. Application Data
(60) Provisional application No. 62/846,225, filed on May 10, 2019.

(51) Int. Cl. G06Q 40/02; G06K 9/62; G06N 5/00; G06N 20/00; G06F 17/18

(52) U.S. Cl. CPC G06Q 40/025; G06K 9/623; G06K 9/6256; G06F 17/18; G06N 5/003; G06N 20/00; G06K 9/6232

(57) ABSTRACT

An embodiment includes executing a machine learning risk prediction model representing a set of credit report data features and a default label space associated with transactions via a data processing system; receiving a request to approve an electronic application for a user; storing credit report data for the user in a user record; extracting a set of credit report data attributes from the user record; creating a feature vector comprising features representing the set of credit report data attributes extracted from the user record; determining a predicted default risk score for the user, comprising processing the feature vector using the machine learning risk prediction model; and updating the first user record for the first user by adding the predicted default risk score to the first user record, wherein the predicted default risk score is used by a data processing system to control an online application approval process.

### RELATED APPLICATONS

This application claims the benefit of priority under 35 U.S.C. § 119(e) to U.S. Provisional Patent Application No. 62/846,225, entitled “Rules/Model-Based Data Processing System for Intelligent Default Risk Prediction,” filed May 10, 2019, which is hereby fully incorporated herein by reference for all purposes.

### TECHNICAL FIELD

The present disclosure relates generally to the field of data processing systems. More particularly, the present disclosure relates to data processing systems that use machine learning to predict risk where the risk prediction may be used to control downstream processing by a data processing system.

### BACKGROUND

In recent years, Internet-based systems and other computer systems that facilitate purchasing items including major assets have become increasingly important tools for both consumers and dealers. For example, vehicle search services provided through the Internet have revolutionized the process of searching for a vehicle and dealer management systems (DMS) have transformed the management of finance, sales, parts, inventory, and administration of other aspects of running a dealership.

In some cases, an entity may allow consumers to finance purchases made through the entity's web site. Conventionally, credit scores provided by credit reporting agencies were used to screen out consumers who were likely to default on financing. However, credit scores may not sufficiently predict risk for the particular types of transactions enabled by a given web site. For example, credit scores may not adequately account for new forms of ownership facilitated by Internet-based sites.

As such, there is a need for computer implemented mechanisms to predict risk. Moreover, there is the need for such mechanisms to provide a prediction of risk in real-time or otherwise in a timely manner to allow purchases via a web site to proceed at the speeds to which Internet users are accustomed.

### SUMMARY

Embodiment described herein provide a machine learning risk prediction model trained to output a prediction of default risk. The machine learning risk prediction model may be a gradient boosting tree model or other suitable model. The machine learning risk prediction model represents a set of credit report data features and a default label space associated with transactions completed by a plurality of users via a data processing system. The risk prediction model can be utilized to determine a predicted risk that may be used to control downstream processing. For example, a predicted risk score may be used to control an online application process e.g., to deny an application, allow an application or to allow an application to proceed for further process. As another example, the predicted risk score may be used to control which inventory items are presented to a user during searches and the payment schedules provided to the user for the inventory items. The machine learning risk prediction model can provide a mechanism to quickly generate a predicted risk score. For example, the machine learning risk prediction model may be used to generate a predicted risk score in the context of a single browser or web application session with a user. Moreover, the machine learning risk prediction model can incorporate insights from transactions facilitated by a data processing system and can thus account for the actual types of transactions specific to the data processing system, providing a more accurate assessment of risk.

According to aspect, a data processing system is provided. The data processing system, according to one embodiment, comprises a memory and a processor. The memory can be configured for storing user records and a machine learning risk prediction model trained to output a prediction of default risk, the machine learning risk prediction model representing a set of credit report data features and a default label space associated with transactions completed by a plurality of users via the data processing system. The processor can be configured to, receive a request to approve an electronic user application for a first user, interact with a remote information provider system to retrieve a set of credit report data for the first user, store the set of credit report data for the first user in a first user record for the first user, the first user record comprising a set of credit report data attributes storing the set of credit report data, extract the set of credit report data attributes from the first user record, create a feature vector representing the first user record, the feature vector comprising features representing the set of credit report data attributes extracted from the first user record, determine a predicted default risk score for the first user, and update the first user record for the first user by adding the predicted default risk score to the first user record. Determining the predicted default risk score comprises processing the feature vector representing the first user record using the machine learning risk prediction model. The predicted default risk score may be used by the data processing system to control an online application approval process.

According to another aspect, a non-transitory computer readable medium is provided. The non-transitory computer readable medium embodies thereon computer program code. According to one embodiment the computer program code comprising instructions for: executing a machine learning risk prediction model representing a set of credit report data features and a default label space associated with transactions completed by a plurality of users via a data processing system; receiving a request to approve an electronic user application for a first user; interacting with a remote information provider system to retrieve a set of credit report data for the first user; storing the set of credit report data for the first user in a first user record for the first user, the first user record comprising a set of credit report data attributes storing the set of credit report data; extracting the set of credit report data attributes from the first user record; creating a feature vector representing the first user record, the feature vector comprising features representing the set of credit report data attributes extracted from the first user record; determining a predicted default risk score for the first user, comprising processing the feature vector representing the first user record using the machine learning risk prediction model; and updating the first user record for the first user by adding the predicted default risk score to the first user record. The predicted default risk score may be used by a data processing system to control an online application approval process.

According to one embodiment, the predicted default risk score is used by a data processing system to control inventory items presented to the first user. In addition, or in the alternative, the predicted default risk score may be used by the data processing system to control payment schedules presented to the first user.

Embodiments may include building (training) the machine learning risk prediction model. For example, embodiments may include: collecting transaction data regarding the transactions completed by the plurality of users via the data processing system, payment histories for the transactions, and credit report data for the plurality of users; storing the transaction data, the payment histories, and the credit report data for the plurality of users in a set of user records; labeling each user record in the set of user records with a class from the default label space; creating a respective feature vector for each user record in the set of user records to create a set of feature vectors, each feature vector in the set of feature vectors comprising features representing a set of credit report data attributes extracted from a respective user record from the set of user records and the class with which the respective user record is labelled; and training the machine learning risk prediction model using the set of feature vectors to output a probability that input data corresponds to a label the default label space. In some embodiments, the probability associated with a selected class output by the machine learning risk prediction model is scaled to generate the predicted default risk score. The machine learning risk prediction model can be automatically and periodically retrained.

According to one embodiment, user records used for training the machine learning risk prediction model may be labeled by a human user (e.g., via interaction with a user operator interface). Thus, labeling each user record in the set of user records may comprise receiving classifications from a user.

According another embodiment, a set of default detection rules are executed on the set of user records. The set of default detection rules can be adapted to classify each user record in the set of user records according to the default label space.

In some embodiments, the machine learning risk prediction model comprises a data pipeline to transform the set of credit report data attributes extracted from a user record into the features of a feature vector.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is diagrammatic representation of one embodiment of a transaction data processing system;

FIG. 2 is block diagram illustrating one embodiment of a data retriever and a default detector processing records from a data store;

FIG. 3 is block diagram illustrating one embodiment of a data retriever and a machine-learning risk modeler processing records from a data store to generate one embodiment of an executable machine learning risk prediction model;

FIG. 4 is block diagram illustrating one embodiment of a prediction generator processing a set of data;

FIG. 5 is a high-level block diagram of one embodiment of an example topology;

FIG. 6 is a block diagram of one embodiment of a software architecture of an automotive data processing system;

FIG. 7 is a flow chart illustrating one embodiment of a credit check process to approve a user application; and

FIG. 8 depicts a diagrammatic representation of one embodiment of a distributed network computing environment where embodiments disclosed can be implemented.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

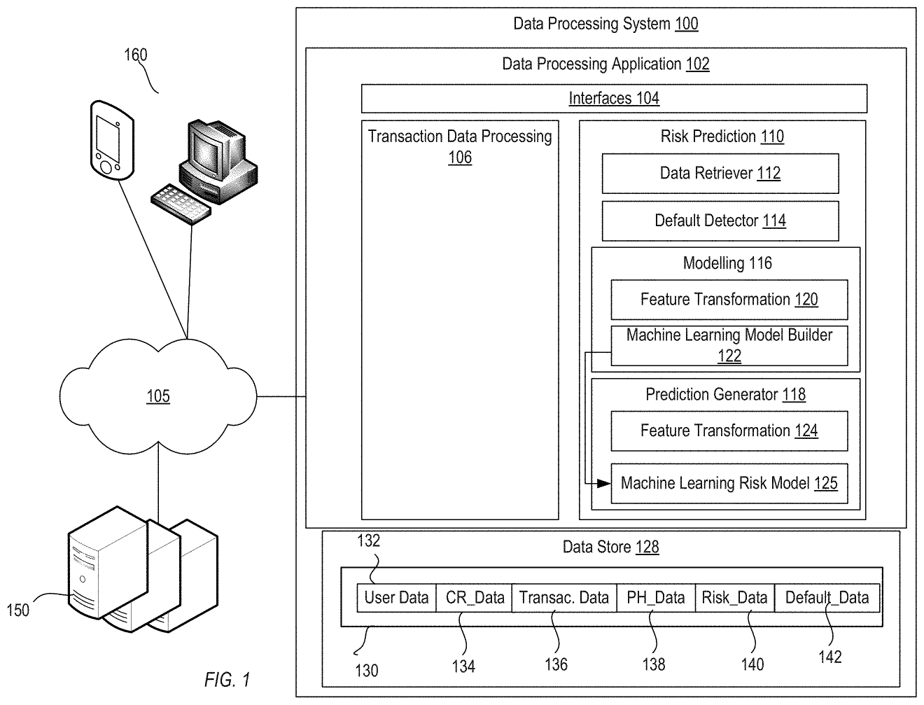

FIG. 1 is diagrammatic representation of one embodiment of a transaction data processing system 100 operating in a network environment. In the example shown in FIG. 1, transaction data processing system 100 is coupled to a plurality of client computing devices 160 and information provider systems 150 by network 105. Network 105 may be, for example, a wireless or wireline communication network such as the Internet or wide area network (WAN), publicly switched telephone network (PSTN) or any other type of communication link.

Transaction data processing system 100 provides a computer system for facilitating online transactions. In some embodiments, data processing system 100 is a system configured to automatically approve user financing or otherwise use user financial information. Data processing system 100, in some embodiments, allows users to purchase (buy, lease, subscribe to) assets using financing. Users can use client computing devices 160 to interact with data processing system 100 to request financing, search and purchase assets or otherwise interact with data processing system 100. A number of users will complete transactions through data processing system 100. That is, a number of users will buy, lease, or subscribe to assets via data processing system 100.

Data processing system 100 is further coupled to a number of information provider systems. Information provider systems 150 may be systems of entities that provide information used in approving a user or purchase. For the sake of explanation, example information provider systems are provided in the context of a data processing system 100 that facilitates the purchase of vehicles (buying, leasing, subscribing to vehicles). As will be appreciated, the types of information provider systems used may depend on the types of inventory items being purchased through data processing system 100. Examples of information provider systems 150 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 150 may comprise any number of other various sources accessible over network 105, which may provide other types of desired data, for example, data used in identity verification, fraud detection, credit checks, credit risk predictions, income predictions, affordability determinations, residual value determinations or other processes.

Transaction data processing system 100 comprises one or more computer systems with central processing units executing instructions embodied on one or more computer readable media where the instructions are configured to perform at least some of the functionality associated with embodiments of the present invention. These applications may include a data processing application 102 comprising one or more applications (instructions embodied on a computer readable media) configured to implement one or more interfaces 104 utilized by data processing system 100 to gather data from or provide data to client computing devices 160 and information provider systems 150. It will be understood that the particular interface 104 utilized in a given context may depend on the functionality being implemented by data processing system 100, the type of network 105 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Data processing application 102 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, data processing application 102 includes transaction data processing code 106 and code to implement a risk prediction system 110. Transaction data processing code 106 is configured to process user requests for financing and/or to purchase assets. Risk prediction system 110 is configured to apply machine learning to enhance user records with a payment risk score, which may also be referred to as a default risk score. Transaction data processing code may use the payment risk score to qualify a user for financing, qualify the user to purchase particular assets or otherwise use the payment risk score.

Data processing application maintains a data store 128 configured to store user records 130. Data store 128 may comprise one or more databases, file systems or other data stores. A user record 130 can comprise a set of related information associated with a user (e.g., associated with a unique id in system 100 for a user). Over time, data processing application 102 builds rich user records 130 using data provided by various sources. While illustrated as a row, a user record 130 may include information distributed in various tables, databases or other data structures that is correlated together as needed.

In the illustrated embodiment, user record 130 includes user data 132, credit report data 134, transaction data 136, payment history data 138, risk prediction data 140 and actual default data. Each portion of user record 130 (e.g., user data 132, credit report data 134, transaction data 136, payment history data 138, risk prediction data 140, actual default data 142) may represent multiple attributes.

User data 132 comprises a user ID, name, address, and other information specific to the user. According one embodiment, data processing application 102 receives a first, limited set of user information from a first source (e.g., from the user), correlates the user record information with additional user information and accounting information from additional sources and uses the additional user information and accounting information to enhance the user record (e.g., to produce an enhanced user record).

According to one embodiment, data processing application 102 provides the user name, user address, user phone number, user email address, date of birth, driver's license number or other information from an application for financing to credit reporting agency systems, which can be examples of information provider systems 150. In response, the credit reporting agency can provide a credit report for a consumer. For example, Experian Information Solutions, Inc. of Costa Mesa, Calif., Equifax, Inc. of Atlanta, Ga., Trans Union, of Chicago, Ill., and other credit reporting agencies provide online systems through which credit reports can be pulled (EXPERIAN, EQUIFAX, TRANS UNION, TRANSUNION, CREDITVISION and other trademarks used herein are the property of their respective owners). In addition to providing a FICO score, a credit report provides status codes indicating various types of events such bankruptcies, delinquent accounts, repossessions, foreclosures, etc. across accounts. As such, a user record 130 can include credit report data 134 comprising information returned in a credit report for the user (e.g., from an information provider system 150). It can be noted that while personally identifiable information (PII) may be sent to an information provider system to request a credit report, PII is generally not used in determining a default risk score in various embodiments.

Transaction data 136 comprises information related to a transaction associated with the user (assets purchased, payment terms and other transaction information). Payment history data 138 comprises a history of payments by the user with respect to a specific transaction. A user record 130 can include risk prediction data 140 indicating a default risk score assigned to the user by risk prediction system 110. A user record 130 can include actual default data 142 comprising a label for indicating whether the user defaulted on the transaction. It can be noted that there may be multiple user records associated with a particular user.

Turning to risk prediction system 110, one embodiment of risk prediction system 110 includes data retriever 112, default detector 114 and risk modeler 116 and prediction generator 118. Risk modeler 116 includes feature transformation module 120 and machine learning model builder 122. Prediction generator 118 includes feature transformation module 124 and an executable machine learning risk prediction model 125.

Data retriever 112 is configured to retrieve user record data from data store 128. For example, data retriever 112 can be configured to search the user records 130 and forward user records data to default detector 114, risk modeler 116 and prediction generator 118.

Default detector 114 analyzes the user records to label each analyzed record according to a configured label space. Such indication may be stored, for example, in the actual default data 142. In particular, actual default data 142 may quantify whether a user/transaction combination resulted in a default. For example, in one embodiment, default detector can analyze transaction data 136 and payment history data 138 to derive the payment dates for an active transaction and whether the user's payment is so overdue as to be considered in default and label records according to actual default status; for example, no_default or default, thus classifying the records. In other embodiments, the records may be labelled by a human user (e.g., an employee of the entity providing financing) reviewing data from records 130.

A training corpus of labelled records 130 can be selected. Feature transformation module 120 is configured to transform attributes from records 130 to features on which to train machine learning risk prediction model 125. According to one embodiment, feature transformation module 120 generates, for each record in a training set of records 130, a feature vector representing user credit report data 134 (and actual default data 142) and inputs the feature vectors from the training set into model builder 122.

Model builder 122 is configured with a target feature on which to train machine learning risk prediction model 125 and applies machine-learning techniques to train machine learning risk prediction model 125. According to one embodiment, the target feature is a feature representing an actual default label space and model builder 122 builds a model trained to analyze input data and output a probability that the input data corresponds to a selected label in the actual default label space.

Prediction generator 118 is configured to process user records using machine learning risk prediction model 125 to generate a default risk score. Feature transformation module 124 is configured to transform attributes from a set of input data, which may be stored in an unlabeled record 130, to features on which to train machine learning risk prediction model 125. According to one embodiment, feature transformation module 124 generates, for each record in a selected set of records 130, a feature vector representing user credit report data 134 and inputs the feature vectors from the set into machine learning risk prediction model 125. Feature transformation module 124 can apply the same transformations to the credit report data as feature transformation module 120. Machine learning risk prediction model 125, according to one embodiment, outputs a probability that a record belongs to a particular class (e.g., a probability that the record corresponds to the default label). Prediction generator 118 may transform the probability (e.g., in the range of 0-1.0) to a score by applying a scaling factor. For example, the probability can be converted to a score of 0-500 or another score.

As described above, feature transformation modules 120, 124 transform data in records into input features on which the model is to be trained or applied. As will be appreciated, a credit report may include hundreds of attributes that can be transformed into features. Examples include, but are not limited to, credit score, other scores included in the credit data, recent credit line history, number of recent credit inquiries for the consumer, number of accounts that are delinquent, how delinquent the accounts are. It can be noted that the time window that is considered “recent” may be a configurable parameter. Feature transformation module 120, 124 can map various credit report attributes to dummy variables or other numeric data, apply feature scaling, bin records into various categories. In general, most attributes of a credit report have continuous values. As such, various bins can be defined (e.g., credit score bins, credit inquiry bins, etc.) and feature transformation modules 120, 124 map the credit report data for a user to the appropriate bins. In some cases, the credit report data for a user may have missing values corresponding to one or more features. According to one embodiment, if an attribute of the credit report data corresponding to a feature is missing a value, the transformation module 120, 124 encodes the corresponding feature using a median value for the attribute.

One non-limiting feature set that may be extracted from a TRANSUNION CREDITVISION (auto) credit report includes: months since oldest trade opened; months since most recent trade opened; total credit line of open trades verified in past 12 months; total credit line of open trades verified in past 12 months (excluding mortgage and home equity); utilization for open trades verified in past 12 months (excluding mortgage and home equity); average balance of open trades verified in past 12 months (excluding mortgage and home equity); months since most recent delinquency; total scheduled monthly payment for all trades verified in past 12 months; number of auto trades; months since oldest auto trade opened; months since most recent auto trade opened; terms in months of most recent auto trade; total balance of all credit card trades verified in past 12 months; months since most recent credit card trade opened; total credit line of open credit card trades verified in past 12 month; percentage of open credit card trades >50% of credit line verified in past 12 months; total open to buy of closed credit cards verified in past 3 month; months since oldest finance installment trade opened; months since most recent finance installment trade opened; number of trades with maximum delinquency of 30 days past due in past 24 months; percentage of trades ever delinquent; months since most recent credit inquiry; months on file; total monthly obligation for individual accounts verified in past 12 months; total monthly obligation for all accounts; months since most recent charged-off trade opened; highest balance of third-party collections verified in 24 months; total past due amount of currently 90 or more days past due trades; number of credit inquiries; number of bank inquiries (includes duplicates) in past 12 months; number of 30 days past due or worse items ever (excluding medical collection items); worst rating on all trades; months since oldest installment trade opened; months since most recent installment trade opened; utilization for open installment trades verified in past 12 months; total scheduled monthly payment for open installment trades verified in past 12 months; months since most recent revolving trade opened; total credit line of open revolving trades verified in past 12 months; total scheduled monthly payment for all revolving trades verified in past 12 months; number of retail trades; months since oldest retail trade opened; months since most recent retail trade opened; number of non-medical third-party collections; current_state; predicted_yearly_income_dollars. It can be noted, however, that other feature sets can be used and, as will be appreciated, the feature set may vary based on the type of underlying credit reports used.

According to one embodiment, model builder 122 is configured to train a gradient boosting tree model. A gradient boosting tree model comprises a first leaf node representing an initial prediction. For example, the initial prediction leaf can represent an initial prediction that a record corresponds to the “default” label. In some embodiments, the initial prediction can be set by configuration (e.g., 0.5). In other embodiments, the initial prediction can be set by a function, such as the natural log of the odds that any record corresponds to the default label, given the training set.

As will be appreciated, labelled records may be split into training, testing and holdout sets. The model is trained on the training set. After training the model on the training set, the model can be applied to the testing set to determine the accuracy of the model. The training and testing can be iterated, changing the model parameters until an acceptable accuracy is achieved or number of iterations has occurred. When the model achieves acceptable accuracy on a testing set, the final model is applied to the holdout to confirm the accuracy. If the model is determined to be sufficient accurate, the model can be deployed as machine learning risk prediction model 125. Otherwise, the model parameters can be changed, and the model retrained. This can be repeated until acceptable accuracy is achieved.

The gradient boosting tree model further comprises a plurality of scaled trees, each tree comprising a plurality of nodes. Each non-leaf node in a tree corresponds to one of the input variables (input features) of the user records. Edges from a non-leaf node to a child node represent each of the possible values of the feature represented by the non-leaf node. Each leaf node represents a class label (e.g., default) and has an associated output value given the values of the input variables represented by the path from the root to the leaf—that is, a leaf node has an output value for the conjunction of input feature values that lead to the leaf node. As will be appreciated, machine learning risk prediction model 125 can determine the probability that a particular set of input feature values belong to a label by applying a function to the initial prediction and the output values of the leaf nodes in each of the plurality of trees that represent that set of input feature values.

It should be noted that the gradient boosting tree model is provided by way of example and other models may be used that represent the features of a credit report and that are configured to output a class label and/or probability for a class label in a class label space. Examples of other models include, but are not limited to random forest, linear models, and neural networks.

Model builder 122 may be executable to implement a model training system as described, for example, in United States Patent Publication No. 2019/0042887, entitled “Computer System for Building, Training and Productionizing Machine Learning Models,” filed Aug. 6, 2018, which is hereby fully incorporated by reference herein for all purposes. As such, the historical credit report data can be transformed to the format of credit report data to which the resulting production machine learning risk prediction model 125 will be applied in the production environment.

According to one embodiment, the feature transformations may be implemented in a data pipeline. A data pipeline comprises data processing elements connected in series to extract raw training data and transform the data to a format used by the machine learning algorithm applied by model builder 122. A data pipeline thus provides a defined way of transforming training data from the model training input format to the format used by the machine learning algorithm. The data pipeline may be frozen with a model generated using data processed by that pipeline and the same series of transformations used to transform the training data can be used, in some embodiments, to transform the production data input to a model that was generated using that pipeline. For example, the data pipeline may be provided in a software container, along with the machine learning algorithms. For example, the software container used for training one of the predictive models may ultimately be used as the production software container, for the trained predictive model, and the data pipeline that was used for training the predictive model may then be used for the productionized predictive model.

During the training phase, a data pipeline can apply functions to the raw data records to process the data for use by a machine learning algorithm. Any number of transformations may be applied in a data pipeline. Non-numeric values may be mapped to numeric values, values in a range may be mapped to the same value, variables may be split, variables may be added (e.g., based on other variables) and other transformations may be applied in the data pipeline. The training data extracted via the data pipeline may be a set of records where each record includes values for input variables and corresponding values for the desired output(s) in the format used by the machine learning algorithm. A trained machine learning risk prediction model 125 may include methods to implement the same data pipeline as was used in training the model. Thus, when the trained model is called to make a prediction, the trained model can process input data using the pipeline, apply the predictive model and generate the prediction score.

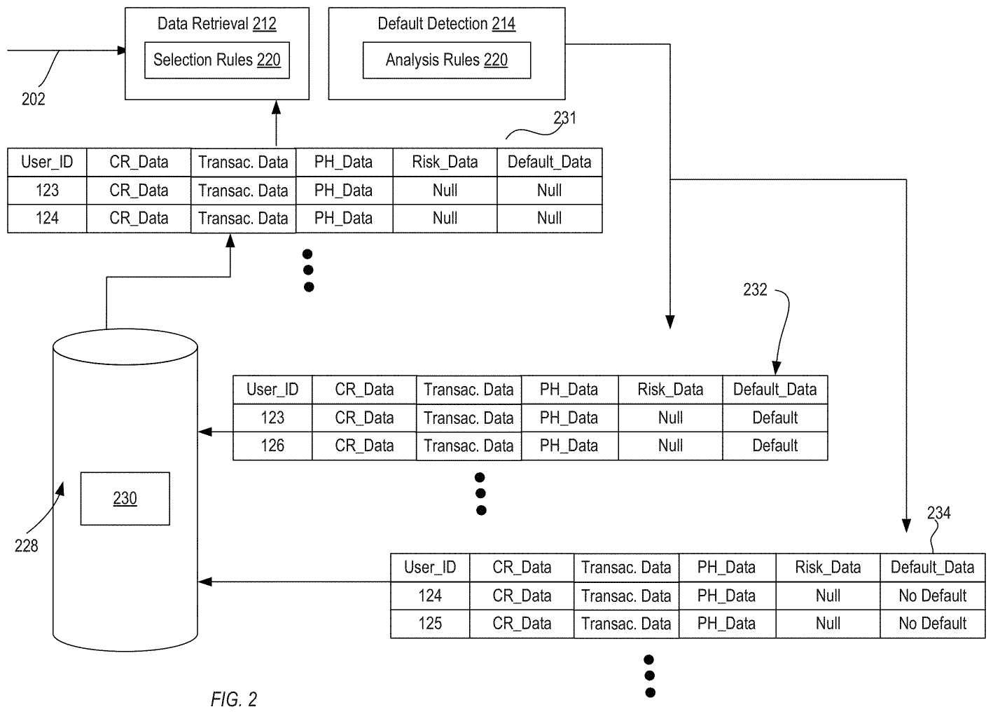

FIG. 2 is block diagram illustrating one embodiment of a data retriever 212 and a default detector 214 processing records 230 from a data store 228. Data retriever 212, default detector 214, records 230 and data store 228 may be implemented, in one embodiment, as data retriever 112, default detector 114, records 130 and data store 128.

According to one embodiment, data store 228 is a data lake that includes records for a large number of users. Data retriever 212 can receive a trigger input 202, such as a task for a processing job. Responsive to input 202, data retriever 212 connects to data store 228 and identifies a set of historical records 231 from records 230 to process. Historical records 231 may comprise records that are older than a threshold, records for which there is sufficient data for default detector 214 to classify the corresponding records or records that meet other criteria.

Data retriever 212 retrieves records 231 and inputs them to default detector 214, which processes the records 231 according to a set of analysis rules 220. Based on analysis rules 220, default detector 214 labels each record in set 231 as default or no_default, classifying records 231 into a default class 232 containing records for which the respective individual defaulted on the transaction and a no default class 234 containing records for which the individual did not default on the transaction. By way of example, but not limitation, one embodiment of default detector 214 examines the transaction data and payment history associated with a record to determine, based on rules 220, whether the record should be labelled as default or no_default. Default detector 214 may, in some embodiments, process historical records according to a schedule, such as daily. For example, a transaction for which payment is more than sixty days (or other period) delinquent may be labeled as in default. In other embodiments, records 231 may be provided to a human user for review and classification into default class 232 and no_default class 234.

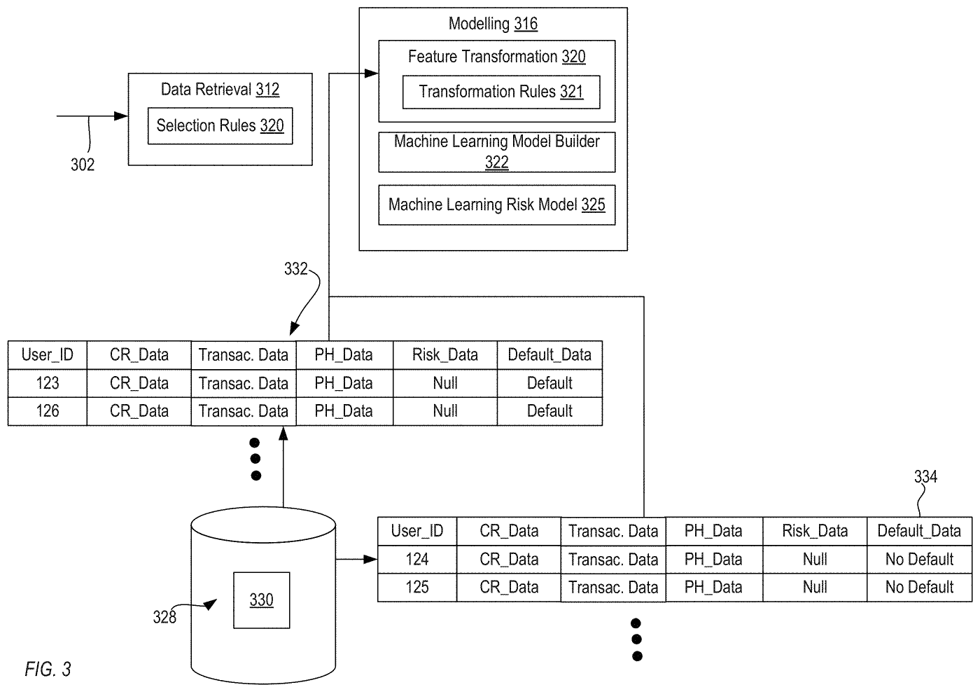

FIG. 3 is block diagram illustrating one embodiment of a data retriever 312 and a machine-learning risk modeler 316 processing records 330 from a data store 328 to generate an executable machine learning risk prediction model 325. Data retriever 312, machine-learning risk modeler 316, records 330, a data store 328 and machine learning risk prediction model 325 may be implemented, according to one embodiment, as data retriever 112, machine-learning risk modeler 116, records 130, a data store 128 and machine learning risk prediction model 125.

Data retriever 312 can receive a trigger input 302, such as a task, to initiate a training job. In some cases, the task may specify the set of data over which the model is to be trained. Data retriever 312 accesses records 330 for historical records that have been classified into default class 332 and no_default class 334 (e.g., by a default detector 114, 214 or a human reviewer) and that meet task criteria for training a model. The system may be configured to retrain machine learning risk prediction model 325 according to a schedule, for example, monthly.

Data retriever 312 retrieves exemplars of each class for which the model is being trained. For example, data retriever 312 retrieves records from class 332 and records from class 334. The exemplar records represent a training corpus for training machine learning risk prediction model 325. A feature transformer 320 transforms each exemplar record in the training corpus to a corresponding feature vector and inputs the feature vectors to a model builder 322 as a training set used to train the machine learning risk prediction model 325. According to one embodiment, feature transformer 320 transforms the exemplar records to feature vectors based on feature mapping rules 321 that specify which attributes of records are to be transformed into features, rules for identifying features from the records and rules for transforming features to feature vectors. Non-limiting examples of attributes and transformation are discussed above with respect to FIG. 1. As will be appreciated, a number of exemplar records may be reserved as a holdout set.

After training risk prediction model 325 on a first set of training data, machine learning risk prediction model 325 can be applied to the holdout set. If the model achieves acceptable accuracy the model can be deployed. Otherwise, the model parameters can be changed, and the model retrained. In particular, candidate models may be trained using hyper parameters in a hyperparameter search space until an acceptable model is found. For a gradient boosting model, for example, the learning rate, min child weight, max depth, max leaf nodes can be adjusted to train candidate models. Parameters for training a gradient boosting tree model may include, for example, learning rate, min child weight, max depth, max leaf nodes, column samples, and row samples. By way of example, but not limitation, N estimators can be tuned on a desired range, such as 300-600, learning rate may be set to a value from 0.001 to 1, and max depth can be in the range of 3-15. Other values may also be used. Retraining can be repeated until acceptable accuracy that meets a pre-defined threshold.

According to one embodiment, machine learning risk prediction model 325 is configured to output a probability that a given a set of input feature values correspond to a particular class.

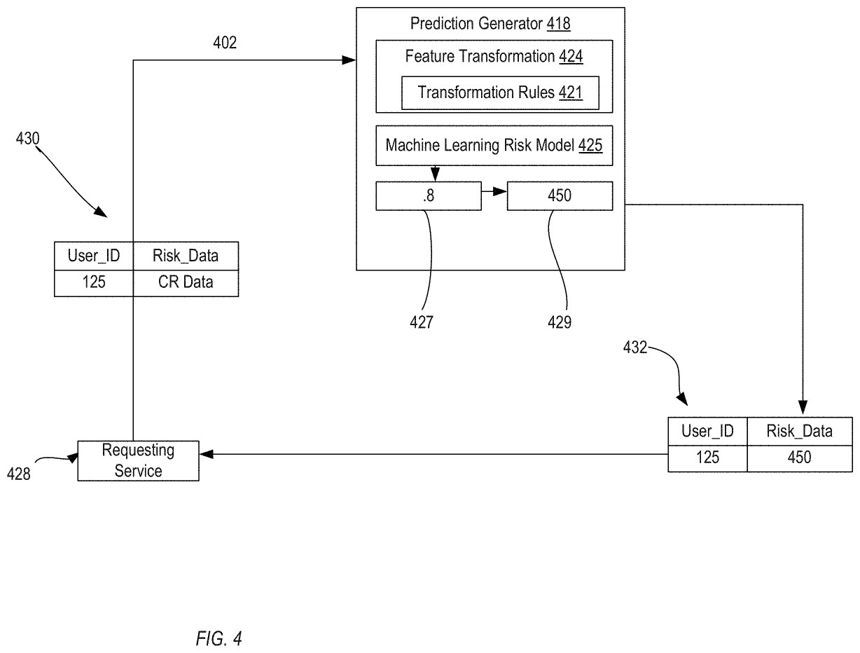

FIG. 4 is block diagram illustrating one embodiment of a prediction generator 418 processing a set of data 430. According to one embodiment, prediction generator 418 is implemented as a prediction generator 118. Prediction generator 418 is configured with an executable machine learning risk prediction model 425, which may be an example of machine learning risk prediction model 125, 325. Machine learning risk prediction model 425 represents features of a credit report and is configured to output a probability 427 that an input set of feature values for the represented features corresponds to a particular class label (e.g., corresponds to a payment default class). According to one embodiment, the machine learning risk prediction model 425 is a gradient boosting tree model.

A requesting service 428 generates a request 402 to prediction generator to provide a prediction for a set of data 430. In this example, set of data 430 includes credit report data associated with a user. A feature transformer 424 transforms credit report data to a corresponding feature vector and inputs the feature vector into machine learning risk prediction model 425. According to one embodiment, feature transformer 424 transforms the credit report data to feature vectors based on feature mapping rules 421 that specify which attributes of records are to be transformed into features, rules for identifying features from the records and rules for transforming features to feature vectors. Non-limiting examples of attributes and transformation are discussed above with respect to FIG. 1.

As discussed above, machine learning risk prediction model 425 is configured to output a probability 427 that a given a set of input feature values correspond to a particular class. For example, according to one embodiment, machine learning risk prediction model 425 accesses an initial prediction that is not dependent on the input feature values, traverses a plurality of trees representing the input features to locate, in each tree, a leaf node representing the conjunction of feature values from the input feature vector, and applies a function to the initial prediction and output values of the located leaves to determine the probability 427 that set of data 430 corresponds to a default class. In some embodiments, the probability may be transformed into a score 429 based on a score transformation function. For example, the probability 0.8 may be scaled to 450.

Prediction generator 418 returns a prediction 432 based on input data 430 to the requesting service 428. The prediction 432 includes risk prediction data (e.g., the probability 427 and/or score 429). In some embodiments, prediction generator 418, requesting service 428 or other service may enhance a user record (e.g., a record 130, 230, 330) with the risk prediction data.

The predicted risk may be used in a variety of ways in a system. The probability 427 or risk score 429 output by prediction generator 118, 418 may be used as a credit risk score by embodiment described in United States Patent Publication 2018/0204281, entitled “Data Processing System and Method for Transaction Facilitation for Inventory Items,” filed Jan. 17, 2018, which is hereby fully incorporated herein by reference for all purposes. Further, according to one embodiment, a user may be assigned a credit risk band based on the default risk score 429 determined for the user.

In some embodiments, a machine learning risk prediction model 125, 325, 425 may be used to provide a credit risk prediction model that can be used by a data processing system as described in United States Patent Publication 2018/0204281. For example, a machine learning risk prediction model 125, 325, 425 may be deployed as a prediction model of a prediction and modeling service as described in United States Patent Publication 2018/0204281.

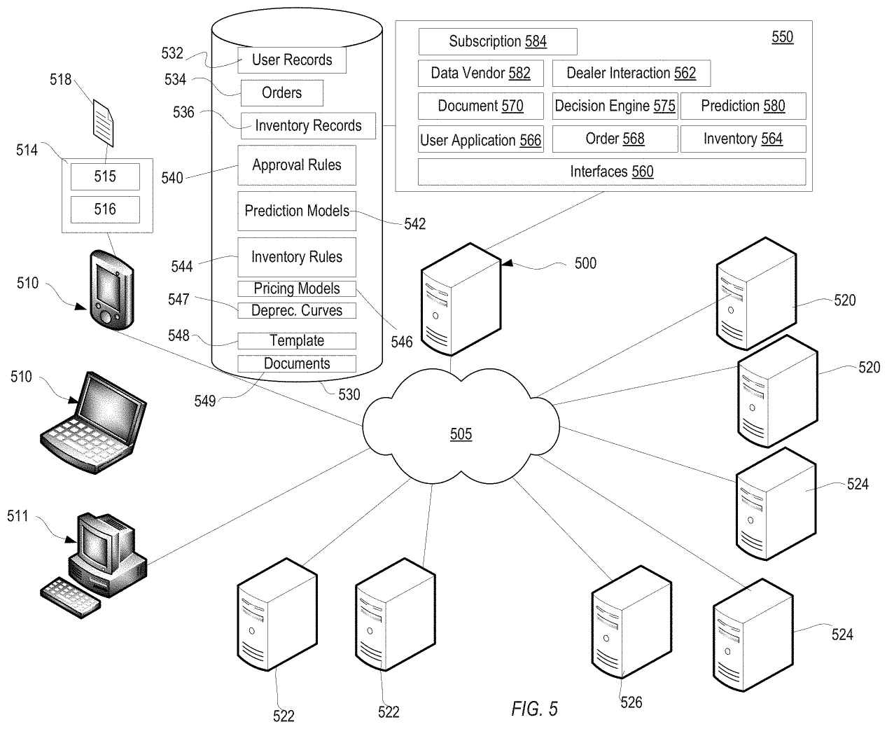

FIG. 5 is a high-level block diagram of one embodiment of an example topology that comprises an automotive data processing system 500 which is coupled through network 505 to client computing devices 510 (e.g. computer systems, personal data assistants, smart phones, or other client computing devices). The topology of FIG. 5 further includes one or more information provider systems 520, one or more dealer management systems (DMS) 522, inventory systems 524, department of motor vehicles (DMV) systems 526 or other systems. Network 505 may be, for example, a wireless or wireline communication network such as the Internet or wide area network (WAN), publicly switched telephone network (PSTN) or any other type of communication link. Automotive data processing system 500 may utilize machine learning prediction models including machine learning risk prediction model.

In accordance with one aspect of the present disclosure, automotive data processing system 500 provides a comprehensive computer system for automating and facilitating a purchase process including financing qualification, inventory selection, document generation and transaction finalization. Using a client application 514 executing on a client computing device 510, a consumer user may apply for financing, search dealer inventory, select a vehicle of interest from a dealer and review and execute documents related to the purchase of the vehicle, and execute automated clearing housing (ACH) transactions through automotive data processing system 500 to purchase the vehicle from the dealership. The automotive data processing system 500 may initiate the consumer's fee payments through various payment methods. Automotive data processing system 500 may be provided by or behalf of an intermediary that finances the purchase of a vehicle by a consumer from the dealer. In this context, a “consumer”, is any individual, group of individuals, or business entity seeking to purchase a vehicle (or other asset) via the system 500.

Turning briefly to the various other entities in the topology FIG. 5, dealers may use a dealer management system (“DMS”) 122 to track or otherwise manage sales, finance, parts, service, inventory, and back office administration needs. Since many DMS 522DMS 522 are Active Server Pages (ASP) based, data may be obtained directly from a DMS 522 with a “key” (for example, an ID and Password with set permissions within the DMS 522) that enables data to be retrieved from the DMS 522. Many dealers may also have one or more web sites which may be accessed over network 505, where inventory and pricing data may be presented on those web sites.

Inventory systems 524 may be systems of, for example, one or more inventory polling companies, inventory management companies or listing aggregators which may obtain and store inventory data from one or more of dealers (for example, obtaining such data from DMS 522). Inventory polling companies are typically commissioned by the dealer to pull data from a DMS 522 and format the data for use on websites and by other systems.

DMV systems 526 may collectively include systems for any type of government entity to which a user provides data related to a vehicle. For example, when a user purchases a vehicle it must be registered with the state (for example, DMV, Secretary of State, etc.) for tax and titling purposes. This data typically includes vehicle features (for example, model year, make, model, mileage, etc.) and sales transaction prices for tax purposes. Additionally, DMVs may maintain tax records of used vehicle transactions, inspection, mileages, etc.).

Information provider systems 520 may be systems of entities that provide information used in approving a user or purchase. Examples of information provider systems 520 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 520 may comprise any number of other various sources accessible over network 505, which may provide other types of desired data, for example, data used in identity verification, fraud detection, credit checks, risk predictions, income predictions, affordability determinations, residual value determinations or other processes.

Automotive data processing system 500 may comprise one or more computer systems with central processing units executing instructions embodied on one or more computer readable media where the instructions are configured to perform at least some of the functionality associated with embodiments of the present invention. These applications may include a vehicle data application 550 comprising one or more applications (instructions embodied on a computer readable media) configured to implement one or more interfaces 560 utilized by the automotive data processing system 500 to gather data from or provide data to client computing devices 510, information provider systems 520, DMS 522, inventory systems 524, DMV systems 526 and processing modules to process information.

Automotive data processing system 500 utilizes interfaces 560 configured to, for example, receive and respond to queries from users at client computing devices 510 interface with information provider systems 520, DMS 522, inventory systems 524, DMV systems 526, obtain data from or provide data obtained, or determined by automotive data processing system 500 to any of information provider systems 520, DMS 522, inventory systems 524, DMV systems 526. It will be understood that the particular interface 560 utilized in a given context may depend on the functionality being implemented by automotive data processing system 500, the type of network 505 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Vehicle data application 550 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 5, vehicle data application 550 includes a dealer interaction module 562 which can provide a service to allow dealers to register with automotive data processing system 500 to allow vehicles to be purchased through automotive data processing system 500. To onboard a dealer, a dealer account may be established at automotive data processing system 500. Various pieces of information may be associated with the dealer account. Once a dealer is on-boarded, dealer interaction module 562 may provide a dealer portal (e.g., a web site, web service) through which the dealer may access and update information for transactions using, for example, a browser at a dealer client computing device 511. The dealer portal may also include a history of previously completed deals and other information.

As part of onboarding, automotive data processing system 500 can be provided with credentials or other information to allow automotive data processing system 500 to access dealer inventory information from the dealer's DMS 522 or an inventory system 524. In addition, or in the alternative other channels may be established to retrieve inventory information (e.g., email, FTP upload or another channel).

The dealer may provide any forms that are required during a sales transaction. For example, state DMVs often mandate specific disclosures and some dealers have their own required disclosure documents that go beyond what is required by the government. The dealer may also provide bank account information to allow funds to be transferred to the dealer to purchase vehicles.

Inventory module 564 receives inventory feeds from remote sources via the channels established with the dealers, enhances the inventory records with information from other, distributed sources, and applies inventory rules 544 to the inventory records to filter the inventory items down to a program pool of inventory items. Inventory rules 544 may further include rules for pricing vehicles based, for example, on a pricing model 546. Automotive data processing system 500 uses the model, or, more particularly, depreciation models 547 derived from the model 546, to accurately determine an initial payment and monthly (or other periodic) payments for each inventory item. The payments may be selected to meet particular metrics. In some embodiments, system 500 may determine an array of payments for each vehicle, the array containing payment schedules for multiple mileage and credit risk bands. Inventory module 564 may store an inventory record 536 for each vehicle in the vehicle pool, the inventory records containing data obtained from inventory feeds, enhanced data from information provider systems 520 and payment schedules. Inventory module 564 may further search inventory records 536 in response to search criteria received from client application 514 or other modules and returns responsive results.

User application module 566 is configured to interact with consumer users accessing system 500 via client applications 514 to obtain appropriate input information from the users to populate user applications for financing. User application module 566 further manages the user applications through an application approval lifecycle. Applications may be persisted as application records (user records) 532.

A decision engine 575 applies approval rules 540 to user application data provided by user application module 566 to approve or deny the application. Examples of approval rules 540 include, but are not limited to, fraud detection rules, identity verification rules, credit check rules, income verification rules and affordability rules. If an application is not approved, decision engine 575 may return the reason that the application was not approved. A failure to pass the approval rules may result in any configured action, such as withholding further information or services from the consumer, requesting the consumer re-enter information or provide additional information, and/or alerting an authority that of the failed check. If an application is approved, the decision engine may return one or more scores including, for example, a risk score, which can be added to the application for the user. The scores may be automatically used as search criteria for searching inventory records 536.

The application of approval rules 540 or other processes may leverage predictions. Prediction module 580 can apply prediction models 542 to data associated with the user application to generate prediction scores that may be used in processing the approval rules 540 or to enhance an application. By way of example, but not limitation, automotive data processing system 500 may apply a machine learning risk prediction model, for example, a machine learning risk prediction model 125, 325, 325) to generate a default risk score for a consumer.

Approval rules 540 and prediction models 542 may require obtaining information from a number of third party distributed systems. As an example, application of a credit check rule may require gathering information from a credit reporting agency information provider system 520. Based at least in part on some of the user application data, a data vendor module 582 may perform interaction with one or more third party sources to obtain various types of information used in applying approval rules 540 and prediction models 542. For example, data vendor module 582 may interact, via appropriate APIs, with information provider systems 520 to collect fraud detection data, identity verification data, credit reports, income estimation data, income projection data and other data.

Order module 568 is configured to interact with consumer users accessing system 500 via client applications 514. Order module 568 is configured to obtain appropriate input information from the users, e.g., via one or more interactive GUls, other modules, or third-party systems to populate order profiles and orders that contain data for purchase decisions. Order module 568 may further interact with the dealer portals to alert dealers of orders involving that dealer and allow dealers to update and approve orders. Order module 568 can manage the user orders 534orders 534 through an order lifecycle. Orders 534 may be persisted as records in data store 530.

A document module 570 can receive order data from order module 568. Document module 570 may access a template of a contract from a library of templates 548, generate an HTML, PDF or other version of the contract by populating the template with data from the order and return the generated contract to the order module 568. The generated document can be provided to client application 514 to allow the user to preview a contract or execute a finalized contract. Automotive data processing system 500 may also maintain a library of other documents 549, such as wear and tear contracts, warranty information, insurance policy documents that may be returned to a user.

System 500 can store or generate documents that may be required by the intermediary, dealers, governmental organizations, or others during the purchase process. Consequently, a consumer can review digital copies of, for example, an ownership agreement and any other ancillary documents that the consumer will likely have to execute in the purchase process. In some cases, some of the documents may be dealer specific or may be optional and may only become available to the consumer after he or she has selected a vehicle of interest or specific F&I options. In any case, in some embodiments, the consumer, prior to the consumer going to the dealership, may review, on his or her client computing device 510, all or a selected portion of the documents that will or may require execution.

System 500 and client application 514 may cooperate to present a list of vehicles to the consumer based on a variety of factors. In some embodiments, the list of vehicles presented to the user is filtered based on a credit risk band associated with the user, the payments determined for the vehicles or other factors, as well as filter criteria provided by the user and vehicle payment parameters provided by the consumer or determined by system 500, while excluding vehicles that do not fit these criteria. In some embodiments, the payment schedules of vehicles presented to the user are based on the credit risk band associated with the user.

Subscription module 584 may receive a payment schedules and financial information from orders and interact with financial institutions to execute the payment schedules.

Furthermore, automotive data processing system 500 may include data store 530 operable to store obtained data, processed data determined during operation and rules/models that may be applied to obtained data or processed data to generate further processed data. In one embodiment, automotive data processing system 500 maintains user applications, orders, and inventory objects. Further, in the embodiment illustrated, data store 530 is configured to store rules/models used to analyze application data, order data and inventory data, such as application approval rules 540, inventory rules 544, prediction models 542, pricing models 546. Data store 530 may comprise one or more databases, file systems or other data stores, including distributed data stores managed by automotive data processing system 500. Data store 530 may thus hold records with, for example, user information, credit report data, transaction data and payment history data. Such data may be used to train a machine learning risk prediction model as discussed above, which may be deployed as a prediction model 542.

Client computing devices 510, 511 may comprise one or more computer systems with central processing units executing instructions embodied on one or more computer readable media where the instructions are configured to interface with automotive data processing system 500. A client computing device 510, 511 may comprise, for example, a desktop, laptop, smart phone, or other device. According to one embodiment, a client computing device 510 is a mobile device that has a touchscreen display and relies on a virtual keyboard for user data input. Client application 514 may be a mobile application (“mobile app”) that runs in a mobile operating system (e.g., Android OS, iOS), and is specifically configured to interface with automotive data processing system 500 to generate application pages for display to a user. In another embodiment, the client application 514 may be a web browser on a desktop computer or mobile device. A client computing device 511 may run an application through which a dealer portal can be accessed.

In accordance with one embodiment, a user can utilize client application 514 to register with automotive data processing system 500, apply for financing, view inventory, select a vehicle, review documents and finalize a sales transaction through a low friction mobile app running on a smart phone. Client application 514 can be configured with an interface module 515 to communicate data to/from automotive data processing system 500 and generate a user interface for inputting one or more pieces of information or displaying information received from automotive data processing system 500. In some embodiments, the client application 514 may comprise a set of application pages through which client application 514 collects information from the user or which client application 514 populates with data provided via an interface 560.

Any type of information may be received from the consumer user in accordance with embodiments of the present disclosure, including consumer information, (such as personally identifiable information (PII) and financial information for that user), order parameters, such as vehicle features (such as the make, model, year, mileage, trim, or other characteristics of a specific vehicle or group of vehicles in which the consumer is interested) and order payment parameters (other parameters that affect the monthly payment, such selections of additional products, an indication of expected usage or other parameters) or other information.

As discussed above, a user may apply for financing via client application 514. To this end, client application 514 may be configured with a series of application pages configured to collect user application data and display user application data. The data may be maintained at the client computing device 510 in a local representation 518 of a user application (a data structure configured to hold user application data). The local representation 518 may include application data to be sent to automotive data processing system 500 or received from automotive data processing system 500.

Client application 514 can be configured to request a minimum amount of user identification information and financial information from a consumer to allow automotive data processing system 500 to make a determination of whether the user is approved to purchase a vehicle and the vehicles for which the user is approved. Preferably the mobile application pages are configured to minimize the number of fields that the user must populate for an approval determination to be made. The user supplied user identification information can be used to obtain additional consumer information from a variety of information provider systems 520.

Information provided by the user can correlated with information from various databases (e.g., credit reporting agencies, financial institutions) to build profile of customer. Client application 514 or vehicle data application 550 can, for example, receive a first, limited set of user record information from a first source (e.g., from the user), correlate the user record information with additional PII and accounting information from additional sources and use the additional PII and accounting information to enhance the user record (e.g., to produce an enhanced user record). The system may use the information from the (enhanced) user record to approve financing.

In one embodiment, an application page of client application 514 is configured to allow a user to input an image of an identification document for the user. Client application 514 may access a mobile device's picture roll or include an imaging module 516 that can access a camera of the client computing device 510 (for example, a smart phone camera) to take an image of a user identification document (for example, a scan or photograph of a driver's license, passport or other user identification document). The image of the user identification document is used to obtain PII for the user using an internal library or a remote information provider system 520. Automotive data processing system 500 may use the PII input directly by the user, obtained using the user identification document image, or otherwise obtained to obtained additional consumer information, including financial information, associated with the consumer from information provider systems 520.

If the user application is approved, system 500 and client application 514 may cooperate to present a list of vehicles to the consumer based on a credit risk band associated with the consumer, the payments determined for the vehicles, as well as filter criteria provided by the user and order payment parameters provided by the consumer or determined by system 500, while excluding vehicles that do not fit these criteria.

In response to a selection of a vehicle from the list, client application 514 and system 500 may cooperate to present additional details of a vehicle to the user. In some embodiments, system 500 may provide the array of payments associated with the vehicle to client application 514. Mobile application can be configured to display a default payment as well as provide payment parameter controls to adjust order payment parameters. Responsive to user input using the payment parameter controls, the mobile application can update the payment displayed. In this example, the mobile application does not have to request additional data from system 500 to update the displayed payment in response to the inputs because the payment array is resident at client application 514. Thus, the number of network calls can be reduced compared to web-based systems that required a browser to call back to the server each time a user adjusted some parameter that affected payment. In other embodiments, the mobile application may call back to system 500 to receive an updated payment amount each time the user adjusts a payment parameter.

When the user is satisfied with his/her selections, the user can select to complete an order via client application 514. Prior to finalizing the order, the system 500 may use consumer information to conduct an additional credit check. A failure to pass the credit check may result in any configured action, such as withholding further information or services from the consumer, requesting the consumer re-enter information or provide additional information, and/or alerting an authority that of the failed identification verification.

System 500 can notify the dealer selling the vehicle subject to an order of the order and the dealer can access the order via a dealer portal for review. The dealer may be required to add additional information to the order, such as current odometer reading. System 500 electronically generates the purchase contract for and sends the purchase contract to client application 514 for electronic signature by the user.

It should be noted here that not all of the various entities depicted in the topology are necessary, or even desired, in embodiments of the present invention, and that certain of the functionality described with respect to the entities depicted FIG. 5 may be combined into a single entity or eliminated altogether. Additionally, in some embodiments other data sources not shown in FIG. 5 may be utilized. FIG. 5 is therefore exemplary only and should in no way be taken as imposing any limitations on embodiments of the present invention.

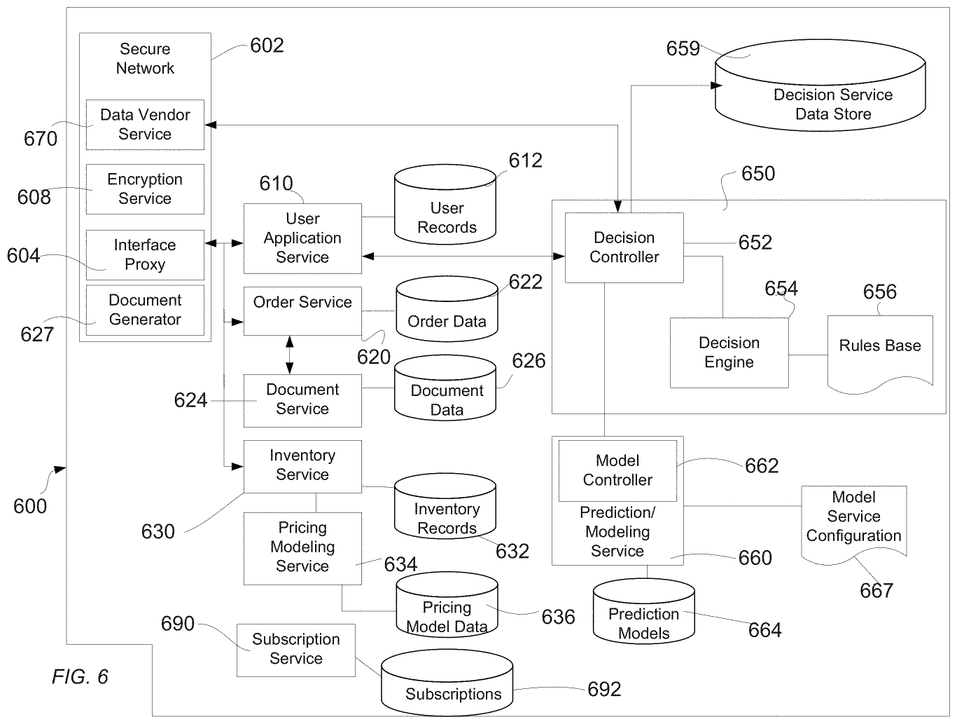

According to one embodiment, various modules discussed above can be implemented as a set of services at one or more servers. FIG. 6 is a block diagram of one embodiment of a software architecture of an automotive data processing system such as automotive data processing system 500. In the illustrated embodiment, software architecture 600 comprises a number of services (which may be independently executing services) including secure network services 602, a user application service 610, an order service 620, an inventory service 630, a document service 624, a decision service 650, a prediction and modelling service (prediction service) 660, a price modeling service 634, a data vendor service 670 and a subscription service 690. Each of user application service 610, decision service 650, prediction service 660, price modeling service 634, order service 620, inventory service 630, document service 624, data vendor service 670 and subscription service 690 may also include interfaces, such as APIs or other interface, so that other services can send calls and data to and receive data from that service.

The services may utilize various data stores operable to store obtained data, processed data determined during operation, rules/models that may be applied to obtained data or processed data to generate further processed data and other information used by the services. In the embodiment illustrated, user application service 610 stores user application records in user application service store 612, decision service 650 stores data in data store 659, order service 620 stores order data in order service data store 622, document service utilizes data stored in document service data store 626, inventory service 630 stores inventory records in inventory service data store 632, price modeling service 634 uses price model data in data store 636, predication service 660 and uses prediction models 664. The various services may utilize independent data stores such the data store of each service is not accessible by the other services. For example, each of user application service 610, decision service 650, order service 620, inventory service 630, document service 624, price modeling service 634 and prediction service 660 may have its own associated database.

Secure network services 602 include interfaces to interface with client computing devices and information provider systems 520. The interfaces can be configured to, for example, receive and respond to queries from users at client computing devices, interface with information provider systems 520, obtain data from or provide data obtained, or determined by architecture 600 to client computing devices or information provider systems. It will be understood that the particular interface utilized in a given context may depend on the functionality being implemented, the type of network utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context. Secure network services 602 provide a walled off segment of the system the system. Certain unencrypted information, such as PII, is not available to other components of the software architecture outside of secure network services 602.

In the embodiment illustrated, secure network services 602 include an interface proxy service 604 that receives calls and data from client applications (e.g., client application 514 or web browser accessing a dealer portal) or services of architecture 600, routes calls and data to the services of architecture 600 and routes responses to the client application or calling service as appropriate. Interface proxy service 604 can provide authentication services, assigning unique user ids to new users, authenticating users when they log back into automotive data processing system 500 and providing other functionality. Once a user has authenticated, interface proxy service 604 can provide context (such as a user id) that can be passed with requests to other services.

Secure network services may also include data vendor service 670 configured to communicate with information provider systems 520 to request information from the information provider systems 520. For example, data vendor service 670 may include APIs for services at information provider systems 520, such as 3rd party services, that provide data incorporated in decisions. Data vendor service 670 may include APIs dedicated to each information provider system 520.

Encryption services 608 are provided to internally encrypt/decrypt sensitive information, such as personally identifiable information (PII), and other information received via data vendor service 670 and interface proxy service 604.

At least some data communicated between automotive data processing system 500 and a client computing device may be encrypted beyond encryption generally used to encrypt communications (such as HTTPs). For example, PII provided by a client application (e.g., client application 514) may be encrypted according to a first encryption protocol. Interface proxy service 604 may forward the encrypted PII for use by other services, such as user application service 610, which cannot decrypt the information.

Information provider systems 520 may require PII to return information about a consumer (e.g., the API for a credit reporting agency information provider system 520 may require inputting a name, address, social security number or other PII to receive a credit report). When data vendor service 670 receives encrypted PII from another service to send to an information provider system 520, data vendor service 670 can call encryption service 608 to decrypt the PII from the internal format and then data vendor service 670 can then encrypt the PII in the encryption format used for the API call to information provider system 520. Similarly if PII is received from information provider system 520 via data vendor service 670, data vendor service 670 can decrypt the PII according to the encryption/decryption used by the particular data vendor, call encryption services 608 to encrypt the PII according to the internal format and forward the encrypted PII to another service. Thus, PII is highly secure because, in some embodiments, it is only ever decrypted at secure network services 602 to be re-encrypted for forwarding to other services.

Interface proxy service 604 and data vendor service 670 may thus be configured with rules regarding which PII is to be encrypted by encryption service 608. Examples of information that can be considered PII based on the rules includes, but is not limited to: first name, last name, middle name, date of birth, email address, government id numbers (social security numbers, driver's license number), address, driver's license bar code scan, driver's license image, phone numbers, signature, insurance card information, bank account number, bank account name, bank account balance, employment information or other information. In some embodiments, the rules will specify which fields of data in an input from a client application or response from an information provider system 520 are to be internally encrypted according to the internal encryption format.

User application service 610 is configured to receive user requests to register with the data processing system, manage user applications and communicate with client applications regarding user applications for approval. In particular, user application service 610 can receive requests to apply for financing along with associated consumer data.

According to one embodiment, a request to initiate an application along with registration information (e.g., an email address) is received via an API call to interface proxy service 604 from client application 514. Interface proxy service 604 route the call and consumer data (for example, including the encrypted PII) to user application service 610. User application service 610 creates a user application having a unique application id for the user. User application service 610 returns the application id to client application 514 (via interface proxy service 604) for use in future communication regarding the application.

The user application may be managed as an object that proceeds through multiple states. The user application may be persisted in user application service data store 212 as a user application record, which may be one example of a user record 532. User application service 610 can further receive additional consumer information from client application 514 and enhance the user application record.

In an exemplary embodiment, user application service 610 is configured to receive an API request routed by interface proxy service 604 for an approval decision for a user application. User application service 610 generates a decision request to decision service 650 requesting a pre-approval decision and provides the decision input attributes required for a decision. User application service 610 is configured to receive a decision result from decision service 650 and generate a response to client application 514. User application service 610 may also take other specified actions based on the decision result. When a user application is approved, user application service 610 may pass context information to order service 620. Such context information may include, for example, consumer PII, user id, application id, default risk score or other information used by order service 620.

As consumers search and view vehicles, order service 620 maintains order profiles for the users containing order context information. An order profile can contain information about a consumer (consumer context data received from user application service 610) and vehicle context data (data about a vehicle currently being viewed). Order service 620 can receive requests to search or view vehicles, add consumer context to the request and forward the request to inventory service 630 to search inventory records. When a user selects to view a vehicle, order service 620 can maintain a record of the vehicle viewed to allow order service 620 to send requests to document service 624 to generate previews of contracts and other documents.

Order service may manage order profiles that hold information about consumers and any vehicle the consumer has selected view. According to one embodiment, when a user application is approved, order service 620 receives consumer context information from user application service 610 and creates an order profile. Further, when a user selects particular vehicles to view, order service 620 receives the vehicle information from inventory service 630. When a user indicates that he/she wishes to finalize a purchase, inventory service 630 can create an order, which may be managed as an object that proceeds through multiple states and may be persisted in order service data store 622.

Document service 624 is configured to generate previews of documents and final documents. In particular, if a user selects to preview a contract or finalize a contract, the order service 620 forwards context data, including consumer information and vehicle information, to order to document service 624 and requests that document service 624 generate a preview of an order or final documents for the order. Document service data store 626 may include multiple templates, such as templates for different geographic regions and document service 624 may apply template selection rules to the order data to select a template from multiple templates from which generate a document. Using a template of a contract from document service data store 626, document service 624 may generate an HTML, PDF or other version of the contract by populating the template with data from the order service and return the generated contract to the order service 620. The order service 620 can then respond to the user's request to view a preview of the contract or the final contract.

Some of the information provided by order service 620 to document service 624 may be encrypted and thus the populated template may include encrypted data. According to one embodiment, secure network services 602 may include a document generator 627. When interface proxy service 604 receives a response to pre-view a document or review a final copy of the document, interface proxy service 604 may send the populated template to document generator 627, which can use encryption service 608 to decrypt the encrypted data and complete the preview or final document using the decrypted data. The completed preview or final document is then returned to client application 514.

Inventory service 630 is configured to ingest and enhance inventory records, filter the inventory records, determine pricing information, publish inventory records to inventory service data store 632 and search inventory records. As part of filtering inventory records and determining pricing, inventory service 630 may use depreciation models generated by price modeling service 634 that correspond to year/make/model/trim and mileage bands. If a depreciation model does not exist for a year/make/model/trim, inventory service 630 can filter out the inventory feed record. If a depreciation model does exist for the year/make/model/trim, inventory service 630 can use the depreciation model to determine payments for a vehicle. A data store 636 may store a pricing model, depreciation models or other data used by price modeling service 634.

Decision controller 652, according to one embodiment, is the main application layer of decision service 650 that routes calls between services and is responsible for logging actions. Decision controller 652 is configured to receive requests for decisions from other services and return decision results. Decision controller may assign a decision request a unique decision identification and return the decision identification to the requesting service. Decision controller 652 may pass a request for a decision along with relevant input data to decision engine 654 and pass the decision result to a requesting service.

Decision engine 654 is a rules-based software system that provides a service that executes decisions on decision inputs in a runtime production environment to generate a decision output. Executing a decision can include applying a set of decision rules to the data to approve/disapprove the action and/or take some responsive action, such as generate an output.

A decision input defines the set of data for which a decision will be made. In automotive data processing system 500, the decision input may be some minimum set of information needed to approve a user and/or a particular transaction, such as the user's name, address, social security number, driver's license number or other information used in the decision process. These values may be encrypted and/or tokenized when passed to decision controller 652. At least a portion of the data to be included in a decision output may be specified by the decision executed.

A decision may have an associated “kind” that indicates the type of decision being implemented. The decision “kind” can be used by other services (e.g., user application service 610) to request a decision or other decisions to reference that decision (to create a tree of decisions). Decision base 656 specifies, for each decision type, rules on how to interpret data to approve/disapprove users or transactions, determine products to offer or make other decisions consistent with regulations, business policy or other constraints. For example, the decision base 656 may specify the approval rules 540 to be applied.

In general, decision engine 654 executes a decision to determine if a set of data meets conditions specified in the decision rules for the decision type and generates an output based on the application of conditions to the data. The data to which the conditions are applied may or may not include the decision inputs. Decisions may reference data sources from defined by decision service 650, predictions from data modeling services and prediction services 660 and sub-decisions and contain rules that are applied to data obtained from information provider systems 520, prediction scores from prediction service 660, sub-decisions, decision inputs or other data.

If a decision references a prediction, decision engine 654 can generate a prediction request to prediction service 660. Prediction service 660 can apply a prediction model to a set of prediction inputs to return a prediction score. A prediction model may be a set of user defined prediction rules or a machine learning model.

According to one embodiment, prediction service 660comprises a model controller 662 that receives prediction requests and delegates the request to the correct prediction model 664 based on rules or to a specific model if the specific model is specified with the prediction request. For example, model controller 662 can be configured to delegate a request for a risk prediction to a currently active machine learning risk prediction model if the income prediction request does not specify a particular income prediction model. In this case, prediction service 660 can process the request using the currently active income prediction model. Modeling service configuration data 667 specifies what models are used and what models are active.

Decisions and prediction models may require data from information provider systems 520. Data vendor service 670 can be used to collect data from information provider systems 520. According to one embodiment, decision service 650 can define and manage data sources, data source versions, data source arguments, and data source records. A data source specifies a set of data from one or more information provider systems 520 (e.g., 3rd party services provided by information provider systems 520) that can be passed to other services. For example, a data source may be a report containing data gathered from one or more information provider system 520. The decision service 650 can maintain a definition of the arguments needed to collect the data for an instance of a data source version, receive argument values from other services, collect the data via data vendor service 670 and pass the data source instance to the requesting service or use the data source instance in executing a decision. Decision service 650 may further cache data source instances for faster retrieval in response to a subsequent request for the data source instance.

According to one embodiment, when decision controller 652 receives a request for a decision, decision engine 654 confirms what data is required to retrieve a data source instance from an information provider system 520 to execute the decision prior to executing an API call to data vendor service 670. Decision engine 654 can cross reference the required arguments for fetching said data source with the arguments provided to decision service 650 for the generating the decision and assess whether the dependencies have been met, resulting in a fetching of the data source report, or not, resulting in decision service 650 responding to the user application service 610 with what further arguments are needed. In response to a complete set of arguments, i) decision engine 654 passes the arguments (which may be encrypted or tokenized) to data vendor service 670, ii) data vendor service 670 collects the data source instance from an information provider system 520 via the API for system (which may use encryption service 608 to decrypt/encrypt PII) and iii) data vendor service 670 provides the data source instance to decision engine 654. Furthermore, decision service 650 may cache the data source instance so that it can respond to requests for the data source within a specified time window with cached data rather than fetching the data again from the information provider system. In some cases, the decision may specify a ‘force’ fetch of a data source, such that decision service 650 fetches a fresh report from data vendor service 670 (e.g., from the third-party vendor) rather than using a cached report instance.

Similarly, according to one embodiment, when the decision engine 654 receives a request for a decision, the decision engine 654 may not know what data is required to make a prediction required by the decision. The decision engine can call over to the prediction service 660 and prediction service 660 informs the decision engine 654 of the data needed for the prediction. For example, if decision engine 654 makes a call to prediction service 660 for an “Risk Prediction version 1”, the prediction service can inform decision engine 654 of the data sources or other data needed to make the prediction. In response, i) decision engine 654 communicates with data vendor service 670 to collect the data sources as described above; ii) passes the data source instances or other data to the prediction service 660; iii) receives the results of the requested prediction from the prediction service 660.

Any data sources required and the data from the data sources used by particular rules in decision making can be specified in the decision rules in decision base 656 or prediction models 664 rather than the decision engine code. From the perspective of decision engine 654, gathering data sources and receiving the results of predictions is simplified as decision engine 654, in some embodiments, need only be able to request a data source instance from and pass arguments to data vendor service 670 to receive a data source instance and request a prediction from and pass arguments to prediction service 660 to receive prediction results from prediction service 660.

Thus, based on the decision type and decision input attributes for the decision that decision engine 654 is being requested to make, decision engine 654 can access the appropriate rules (e.g., from decision base 656), retrieve the required data sources and/or prediction scores, process the decision rules to generate a decision result and return the decision result to the requesting service. The decision result may include the id of the decision and metadata about the decision including, for example, an indication of whether the decision result was a pass or a fail, prediction scores generated when making the decision, decline codes indicating why the decision failed or other decision metadata.

Decision controller 652 returns the decision result to the calling service (e.g., user application service 610). Decision controller 652 may also store data associated with the decision in decision service data store 659 (such as, but not limited to, decision type, decision inputs, model identifier, prediction inputs, prediction scores, data source instances, decision result metadata).

User application service 610 is configured to update the appropriate user application record with the decision result data to update the state of the user application. User application service 610 further includes rules to map decision results to actions. According to one embodiment, if the decision result indicates a pass, user application service 610 can generate a response to the preapproval requesting from client application 514 and send the response to the client application 514 via interface proxy service 604. Client application 514 can be configured to proceed to a next stage in the purchase process by, for example, displaying an application page corresponding to the next stage on the client computing device 510.

User application service 610 can categorize decline codes as soft and hard declines. Soft decline codes may be mapped to responses to request additional information or provide instructions to the user to take some action, such as call a customer service representative. Based on the soft decline code, user application service 610 can generate the appropriate response and send the response to the client application 514 via interface proxy service 604. Based on the decline response, client application 514 can display the appropriate application page to allow the user to input additional information or provide instructions to the user on how to continue the application stage. In response to receiving the requested additional information from the user, user application service 610 can request that the preapproval decision be reevaluated by decision service 650.

A hard decline, on the other hand, terminates the application stage. User application service 610 may send a hard decline response to client application 514 and client application 514 can display an application page indicating that the user application has been denied and the reasons for the denial. In some cases, user application service 610, responsive to a hard decline code, may send the user application record data to a service configured to report the decline to a credit reporting agency, generate a letters to report the hard decline or take other actions.

Subscription service 690 may receive a payment schedules and financial information from orders, store subscriptions (e.g., in subscription service data store 692) containing the payment schedule and financial information necessary to interact with a consumer's financial institution and interact with financial institutions to execute the payment schedule.

A number of checks may be implemented as part of the approval process for a user application. Examples of various checks include, but are not limited to, identification verification, initial checks (e.g., minimum age, minimum income, etc.), fraud detection, identity verification and other checks. Some examples of application approval rules are described United States Patent Publication 2018/0204281.

As discussed above, automotive data processing system 500 may receive a request to approve an application from client application 514. Vehicle data application 550 applies approval rules comprising initial checks, fraud detection rules, identity verification rules, credit check rules, income verification rules and affordability rules. In one embodiment, the approval rules may be implemented as one or more decisions executed by decision service 650.

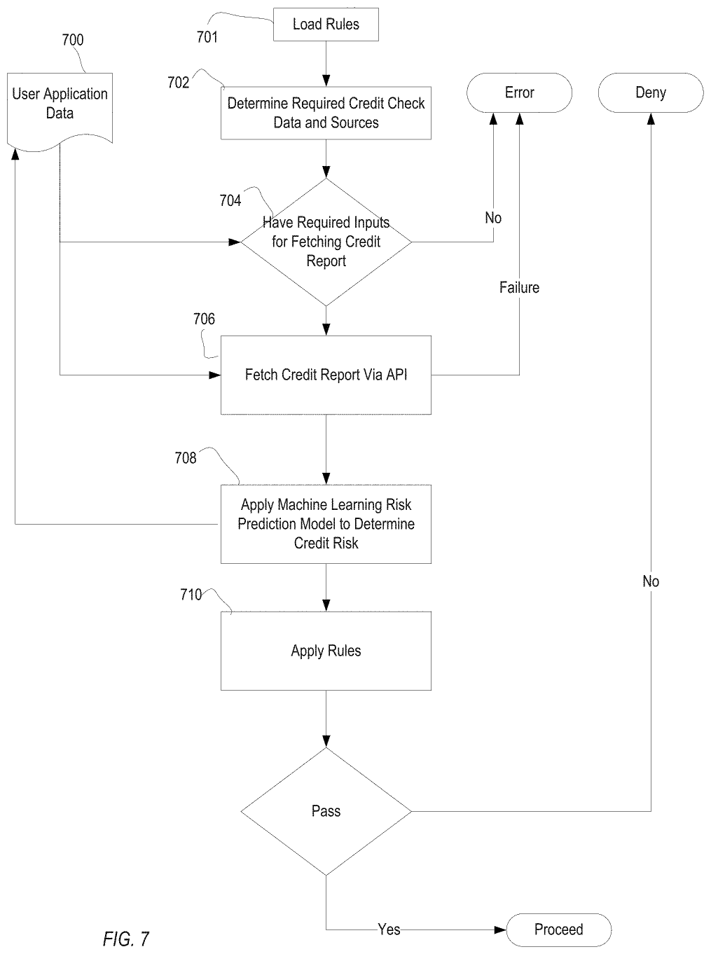

FIG. 7 is a flow chart illustrating one embodiment of a credit check process to approve a user application 700. Vehicle data application 550 can load credit check rules 701 and determine the data from information provider systems 520 needed to execute the rules (step 702). This may include determining any data required by a risk prediction model. At step 704, vehicle data application 550 determines if the user application 700 includes the inputs required to fetch a credit report (or other credit check data) from an information provider system 520, such as a credit reporting agency, or cache. If not, an error can be generated. Vehicle data application 550 may generate a decision response to client application 514 to cause client application 514 to request the additional information necessary to fetch the credit report.

If vehicle data application 550 has the information necessary to fetch the credit report corresponding to the user application 700, vehicle data application 550 may fetch the credit report from cache (if available and not stale) or use the API for the credit reporting agency to submit user application data, such as PII, and fetch the credit report (step 706). If a failure occurs while pulling the credit report, vehicle data application 550 may generate an error.

At step 708, vehicle data application 550 applies the credit risk prediction model to determine a default risk score. As discussed above, the risk prediction model may transform the credit report data into a feature vector and evaluate the feature vector to determine a probability that the consumer will default. As discussed above, this probability may be scaled to create a final risk score. The default risk score for the consumer may be added to user application 700.

A credit risk prediction model may contextualize data analysis. For example, one piece of information (or combination thereof) may be analyzed differently depending on the results of analyzing another piece of information (or combination thereof). The data returned by one information provider system 520 (e.g., returned by one credit reporting agency), for example, may be analyzed differently based on the results of evaluating data from another information provider system 520 (e.g., returned by another credit reporting agency).

At step 710, vehicle data application 550 can apply the credit check rules to the credit report or default risk score. The following provides one example of credit check rules.

If:

Default Risk Score >= Threshold
Pass

Else:

Fail

where the threshold is a configurable parameter.

In the foregoing example, the credit check rules apply to a risk score to determine if an application 700 passes the credit check rules. The credit check rules may be complex and rely on data from additional or alternative sources. Failing the credit check rules may result in requesting more information from the user or taking other configured actions.

If the application does not pass the credit check rules, vehicle data application 550 can deny the application. Vehicle data application 550 can update the application 502 with the reason for the denial and generate a decision response to client application 514 to cause client application 514 to request additional information or terminate the approval process.

In some embodiments, a set of credit risk bands are defined for vehicle data application. The default risk score may be used to categorize the consumer into a credit risk band. The vehicles or vehicle payment schedules offered to the consumer by vehicle data application 550 may depend on the risk score predicted for the consumer or credit risk band to which the consumer is assigned. Thus, the default risk score output by the machine learning risk prediction model can control what vehicles and/or payment schedules are offered to the consumer.

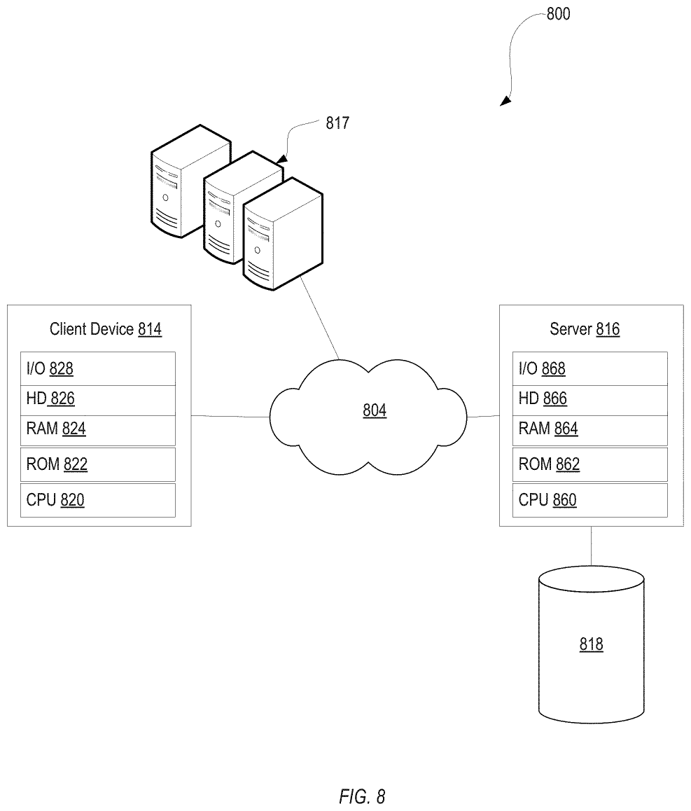

FIG. 8 depicts a diagrammatic representation of a distributed network computing environment where embodiments disclosed can be implemented. In the example illustrated, network computing environment 800 includes network 804 that can be bi-directionally coupled to a client computing device 814, a server system 816 and one or more third party systems 817. Server system 816 can be bi-directionally coupled to data store 818. Network 804 may represent a combination of wired and wireless networks that network computing environment 800 may utilize for various types of network communications known to those skilled in the art.

For the purpose of illustration, a single system is shown for each of client computing device 814 and server system 816. However, a plurality of computers may be interconnected to each other over network 804. For example, a plurality of client computing devices 814 and server systems 816 may be coupled to network 804.

Client computer device 814 can include central processing unit (“CPU”) 820, read-only memory (“ROM”) 822, random access memory (“RAM”) 824, hard drive (“HD”) or storage memory 826, and input/output device(s) (“I/O”) 828. I/O 828 can include a keyboard, monitor, printer, electronic pointing device (e.g., mouse, trackball, stylus, etc.), or the like. In one embodiment I/O 828 comprises a touch screen interface and a virtual keyboard. Client computer device 814 may implement software instructions to provide a client application configured to communicate with a data processing system (e.g., data processing system 100, automotive data processing system 500). Client computer device depicts one embodiment of a client computer device 160, 510, 511. Likewise, server system 816 may include CPU 860, ROM 862, RAM 864, HD 866, and I/O 868. Server system 816 may implement software instructions to implement a variety of services for a data processing system (e.g., data processing 100, automotive data processing system 500). These services may utilize data stored in data store 818 and obtain data from third party systems 817. Many other alternative configurations are possible and known to skilled artisans.

Each of the computers in FIG. 8 may have more than one CPU, ROM, RAM, HD, I/O, or other hardware components. For the sake of brevity, each computer is illustrated as having one of each of the hardware components, even if more than one is used. Each of computers 814 and 816 is an example of a data processing system. ROM 822 and 862; RAM 824 and 864; storage memory 826, and 866; and data store 818 can include media that can be read by CPU 820 or 860. Therefore, these types of memories include non-transitory computer-readable storage media. These memories may be internal or external to computers 814 or 816.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines, or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods, or programs of embodiments of the invention described herein. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums. In some embodiments, data may be stored in multiple databases, multiple filesystems, or a combination thereof.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description (including the Summary and Abstract) is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A data processing system comprising:
a memory for storing user records and a machine learning risk prediction model trained to output a prediction of default risk, the machine learning risk prediction model representing a set of credit report data features and a default label space associated with transactions completed by a plurality of users via the data processing system;
a processor configured to;
receive a request to approve an electronic user application for a first user;
interact with a remote information provider system to retrieve a set of credit report data for the first user;
store the set of credit report data for the first user in a first user record for the first user, the first user record comprising a set of credit report data attributes storing the set of credit report data;
extract the set of credit report data attributes from the first user record;
create a feature vector representing the first user record, the feature vector comprising features representing the set of credit report data attributes extracted from the first user record;
determine a predicted default risk score for the first user, comprising processing the feature vector representing the first user record using the machine learning risk prediction model; and
update the first user record for the first user by adding the predicted default risk score to the first user record, wherein the predicted default risk score is used by the data processing system to control an online application approval process.

2. The data processing system of claim 1, wherein the predicted default risk score is used by the data processing system to control inventory items presented to the first user.

3. The data processing system of claim 1, wherein the predicted default risk score is used by the data processing system to control payment schedules presented to the first user.

4. The data processing system of claim 1, wherein the machine learning risk prediction model is a gradient boosting tree model.

5. The data processing system of claim 1, wherein the processor is configured to:
collect transaction data regarding the transactions completed by the plurality of users via the data processing system, payment histories for the transactions, and credit report data for the plurality of users;
store the transaction data, the payment histories, and the credit report data for the plurality of users in a set of user records;
label each user record in the set of user records with a class from the default label space;
create a respective feature vector for each user record in the set of user records to create a set of feature vectors, each feature vector in the set of feature vectors comprising features representing a set of credit report data attributes extracted from a respective user record from the set of user records and the class with which the respective user record is labelled; and
train the machine learning risk prediction model using the set of feature vectors to output a probability that input data corresponds to a label the default label space.

6. The data processing system of claim 5, wherein the processor is configured to scale the probability to generate the predicted default risk score.

7. The data processing system of claim 5, wherein labeling each user record in the set of user records comprises receiving classifications from a second user.

8. The data processing system of claim 5, wherein the processor is configured execute a set of default detection rules on the set of user records, the set of default detection rules adapted to classify each user record in the set of user records according to the default label space.

9. The data processing system of claim 1, wherein the processor is configured to periodically retrain the machine learning risk prediction model.

10. The data processing system of claim 1, wherein the machine learning risk prediction model comprises a data pipeline to transform the set of credit report data attributes extracted from the first user record into the features of the feature vector.

11. A non-transitory computer readable medium embodying thereon computer program code, the computer program code comprising instructions for:
executing a machine learning risk prediction model representing a set of credit report data features and a default label space associated with transactions completed by a plurality of users via a data processing system;
receiving a request to approve an electronic user application for a first user;
interacting with a remote information provider system to retrieve a set of credit report data for the first user;
storing the set of credit report data for the first user in a first user record for the first user, the first user record comprising a set of credit report data attributes storing the set of credit report data;
extracting the set of credit report data attributes from the first user record;
creating a feature vector representing the first user record, the feature vector comprising features representing the set of credit report data attributes extracted from the first user record;
determining a predicted default risk score for the first user, comprising processing the feature vector representing the first user record using the machine learning risk prediction model; and
updating the first user record for the first user by adding the predicted default risk score to the first user record, wherein the predicted default risk score is used by a data processing system to control an online application approval process.

12. The non-transitory computer readable medium of claim 11, wherein the predicted default risk score is used by the data processing system to control inventory items presented to the first user.

13. The non-transitory computer readable medium of claim 11, wherein the predicted default risk score is used by the data processing system to control payment schedules presented to the first user.

14. The non-transitory computer readable medium of claim 11, wherein the machine learning risk prediction model is a gradient boosting tree model.

15. The non-transitory computer readable medium of claim 11, wherein the computer program code further comprises instructions for:
collecting transaction data regarding the transactions completed by the plurality of users via the data processing system, payment histories for the transactions, and credit report data for the plurality of users;
storing the transaction data, the payment histories, and the credit report data for the plurality of users in a set of user records;
labelling each user record in the set of user records with a class from the default label space;
creating a respective feature vector for each user record in the set of user records to create a set of feature vectors, each feature vector in the set of feature vectors comprising features representing a set of credit report data attributes extracted from a respective user record from the set of user records and the class with which the respective user record is labelled; and
training the machine learning risk prediction model using the set of feature vectors to output a probability that input data corresponds to a label the default label space.

16. The non-transitory computer readable medium of claim 15, wherein the computer program code further comprises instructions for scaling the probability to generate the predicted default risk score.

17. The non-transitory computer readable medium of claim 15, wherein labeling each user record in the set of user records comprises receiving classifications from a second user.

18. The non-transitory computer readable medium of claim 15, wherein the computer program code further comprising instructions for executing a set of default detection rules on the set of user records, the set of default detection rules adapted to classify each user record in the set of user records according to the default label space.

19. The non-transitory computer readable medium of claim 11, wherein the computer program code further comprises instructions for periodically retraining the machine learning risk prediction model.

20. The non-transitory computer readable medium of claim 11, wherein the machine learning risk prediction model comprises a data pipeline to transform the set of credit report data attributes extracted from the first user record into the features of the feature vector.
